(19) United States
(12) Patent Application Publication
(10) Pub. No.: US 2004/0219088 A1
(43) Pub. Date: Nov. 4, 2004

(54) Mini ammonia plant

(76) Inventors: Harvey Wen, Boyds, MD (US); Ram G. Narula, Boyds, MD (US); Linda Katherine Trocki, Tiburon, CA (US)

Correspondence Address: Harvey Wen, Bechtel Power Corp., 5275 Westview Dr., Frederick, MD, 21703-8306, US

(21) Appl. No.: 10/658,085

(22) Filed: Sep. 9, 2003

Related U.S. Application Data
(60) Provisional application No. 60/466,200, filed on Apr. 29, 2003.

(51) Int. Cl. C01C 1/04

(52) U.S. Cl. 423/359

(57) ABSTRACT

This patent application provides a mini-ammonia plant design that is suitable for on-site ammonia production from natural gas feedstock. Its primary application is to supply ammonia to power plant selective catalytic reduction (SCR) facilities for NOₓ abatement. The ideal plant size is less than 5 tons per day per train, but larger size plant can also be designed. In addition to the intended SCR applications, it can also be used in distributed nitrogen generation for industrial or agricultural applications. This mini-ammonia plant eliminates the need for importing ammonia or on-site manufacturing of ammonia from urea. Anhydrous ammonia is a toxic material, and its transportation to power plants located in urban areas is generally prohibited. The invention described in this patent allows the on-site production of small quantity of ammonia in an economical and energy efficient manner. It produces a pre-conditioned hot ammonia/air mixture or hot ammonia gas stream suitable for use in SCR applications.

### CROSS-REFERENCE TO RELATED APPLICATIONS

This application claims the benefit of Provisional Patent Application (PPA) No. 60/466,200, filed on Apr. 29, 2003 by the present inventors.

### FEDERAL SPONSORED RESEARCH

Not Applicable

### FIELD OF THE INVENTION

This invention involves a mini-ammonia production plant using natural gas as its feedstock. Its primary application is to supply gaseous ammonia to a power plant's selective catalytic reduction (SCR) reactor or selective non-catalytic reduction (SNCR) system for NOₓ reduction in flue gas streams. It also has applications in distributed ammonia production for agricultural or industrial purposes.

### BACKGROUND OF THE INVENTION

Ammonia is the reagent used in NOₓ reduction for flue gas streams. In the SCR, ammonia vapor is injected upstream of the SCR catalyst modules, where it will react with NOₓ to form elemental nitrogen and water vapor. This same reaction will occur in the SNCR process, but with less conversion efficiency. SCR with ammonia is capable of >90% NOₓ removal, while SNCR has a removal efficiency of about 50%.

Currently, ammonia needed for SCR or SNCR is supplied from one of the following sources: anhydrous ammonia, aqueous ammonia, or on-site generation using the urea hydrolysis process. Anhydrous ammonia is a hazardous material, and on-site bulk storage is not allowed in most areas. Aqueous ammonia which contains mostly water is expensive for this application. Ammonia from urea has the highest operating cost due to the high cost of urea, but it is a safe system because it eliminates the need for ammonia storage.

Industrial ammonia is generally manufactured in large capacity plants (1000 tons per day or larger) using natural gas as its feedstock. However, for utility-size gas turbines in the U.S. (150 MW power output or larger), less than 2 tons per day of ammonia vapor is needed for SCR NOₓ control. Even with a 350 MW coal-fired unit, only about 5 tons per day of ammonia is needed for SCR. Ammonia plants at these sizes do not exist because the ammonia manufacturing process is complex, and economical production of such a small quantity of ammonia is not feasible at present.

SCRs require the use of diluted ammonia vapor. When air is used as a diluent, the ammonia/air mixture needs to be heated so that it does not cool the flue gas entering SCR and degrade its effectiveness. Ammonia production creates excess waste heat and could be used for this heating purpose. The process design in this invention employs a method of using waste heat from ammonia synthesis reactors to generate a hot ammonia and air mixture for feeding SCR.

Either anhydrous ammonia or aqueous ammonia can be produced in this design. For SCR applications, the anhydrous ammonia option is a better design because it is simpler and less costly. For distributed ammonia generation for other applications, generation of aqueous ammonia may have advantages due to its ease of storage and transportation.

The commercial ammonia production technology requires a minimum of over 1000 tpd capacity to be economical. This invention provides a unique method of making only a few tons per day of ammonia economically. The process includes novel thermal integration schemes that produces refrigeration for ammonia condensing and recovers the waste heat from reactors to heat the product gas.

### SUMMARY OF INVENTION

The present invention provides a method and apparatus for generating a small amount of ammonia on-site from natural gas feedstock. This invention eliminates the need to import ammonia or urea and replaces it with low-cost on-site generation.

A packaged natural gas-to-hydrogen plant is employed as the source of hydrogen and nitrogen for ammonia production. The small hydrogen plant has been developed recently by various hydrogen fuel cell developers. The effluent gas from the hydrogen plant contains impurities including mainly carbon oxides, water vapor, and excess nitrogen. A pressure swing adsorption gas treating system is employed to clean up these impurities and remove excess nitrogen to maintain a hydrogen-to-nitrogen ratio of 3:1. This molar ratio is required for the ammonia synthesis reaction.

The clean gas is then compressed before entering the methanation reactor; where the residual carbon dioxide and carbon monoxide are removed by converting them to methane and water vapor.

The carbon oxide free gas is then compressed in a charge compressor to a desired pressure and heated before entering a multi-stage (2 to 3) ammonia synthesis reactor. The ammonia synthesis reaction is exothermic. At the exit of the reactors, a cooled recycle gas is injected to control the reactor temperature.

The reactor effluent gas is first cooled through heat exchange with the inlet gas. Additional coolers are used to cool the gas before it enters the ammonia condenser. The condensed ammonia is collected in the ammonia knockout drum. The drum's overhead vapor is recycled back to the charge compressor inlet and to provide cooling gas for reactor inter-stage cooling. A small amount of gas is purged through a membrane separator, where hydrogen is separated for recycle and the remaining purged gas is vented to the product gas stream. The condensed ammonia is withdrawn from the ammonia knockout drum through a Joule-Thomson valve or a capillary tube, where the liquid ammonia expands to provide chilling for the ammonia condenser. The product ammonia gas is heated by recovering reactor waste heat or it is mixed with a hot dilution air (heated by recovered reactor waste heat) for use in SCR as the reagent for NOₓ reduction.

The advantages of this on-site ammonia generation are:

Eliminate the need for importing ammonia to the ammonia users

Provides pre-conditioned hot ammonia gas or hot ammonia/air mixture to meet the SCR feed gas requirements

The purge gas streams from gas treating and ammonia condenser are included in the product gas to eliminate emissions from the system

In most cases, this system is expected to have an economic advantage over importing ammonia or making it through urea hydrolysis.

### BRIEF DESCRIPTION OF THE DRAWINGS

FIG. 1 is a process flow diagram of a preferred embodiment of the present invention. It is designed for use in supplying diluted ammonia air mixture for power plant SCR systems.

FIG. 2 is a process flow diagram of an alternative embodiment of the present invention. It is designed for use in supplying hot ammonia vapor (to 300° F. or higher) for use in SCR. The hot ammonia design eliminates the need for heating the air/ammonia mixture before entering SCR.

FIG. 3 is another alternative embodiment. It is used to generate pure ammonia at normal ambient temperature for industrial applications. In this case, the purge gas is vented or burned in a furnace.

### DETAILED DESCRIPTION OF THE INVENTION

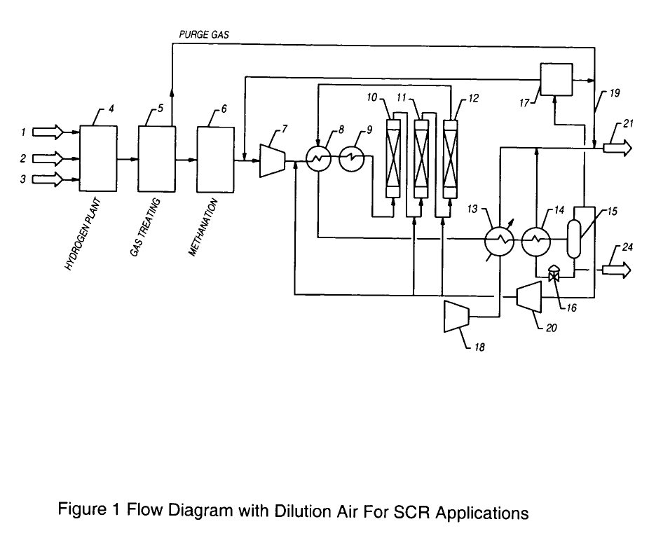

FIG. 1 depicts a flow diagram for the production of ammonia with dilution air for SCR or SNCR applications. Streams 1, 2, and 3 are natural gas fuel, water, and air supply, respectively. These are feed streams to the packaged hydrogen plant 4. The main component in the hydrogen plant is a steam reformer or a partial oxidation reformer. In the preferred embodiment, a catalytic partial oxidation reformer (CPOX) is used, but other non-catalytic partial oxidation (POX) or steam reformers can also be employed. In the catalytic or non-catalytic partial oxidation reformer, air is used as the oxidant. If a steam reformer is used, a separate nitrogen plant is needed. The reaction product from POX or CPOX contains hydrogen, carbon monoxide, carbon dioxide, nitrogen, and water vapor. This reaction product is further processed by water shift reaction to convert carbon monoxide to hydrogen and carbon dioxide. The hydrogen plant effluent gas contains hydrogen, nitrogen, carbon dioxide, water vapor, and a trace amount of un-reacted carbon monoxide.

A gas treating system 5 is employed to remove carbon dioxide and to adjust nitrogen content in the gas stream. A pressure swing adsorption (PSA) type gas treating system is preferred for this application. Other carbon dioxide removal processes such as an amine system can also be used in lieu of the PSA system. The PSA system is designed to provide a hydrogen to nitrogen ratio of approximately 3:1 in the treated effluent gas stream. If an amine system is used, a larger downstream ammonia synthesis reactor purge system is needed, as amine does not remove nitrogen. Since the treated gas from 5 still contains a trace amount of carbon monoxide and carbon dioxide, a methanation system 6 is used to convert these compounds to methane and water vapor. Methanation is a commercial technology used in existing ammonia manufacturing facilities for the same purpose.

The methanation system exit gas is compressed by a charge compressor 7 to a high pressure of about 170 bar. The compressor discharge gas is heated in an ammonia synthesis reactor outlet gas/inlet gas heat exchanger 8 and a trim heater 9. The trim heater 9 is also used as a startup heater. The heated gas is then fed to two- or three-stage ammonia synthesis pipe reactors. In this figure, three reactors 10, 11, and 12 are used. These reactors are filled with ammonia catalyst that promotes the reaction of hydrogen and nitrogen to become ammonia. Since the ammonia synthesis reaction is an exothermal reaction, a cold gas is mixed at the first and second reactor exit gas to maintain a suitable reactor inlet gas temperature for the subsequent stages. The final reactor outlet gas contains 17 to 25% of ammonia gas and the remaining are un-reacted hydrogen and nitrogen. This reactor outlet gas is cooled by heat exchanger 8 and then followed by the SCR dilution air heater 13, where the hot gas is cooled by dilution air from the dilution air blower 18. Heat exchanger 13 effluent is further cooled in the ammonia condenser 14. In the condenser, ammonia is cooled and condensed and is collected in the ammonia knockout drum 15. The non-condensable gas from the ammonia knockout drum 15 enters the suction side of the recycle compressor 20 for recycle back to the heat exchanger 8. A portion of this recycle gas is used as reactor cooling gas. A purge stream from the ammonia knockout drum 15 is sent to a membrane separator 17, where hydrogen is separated for recycle back to the charge compressor 7 inlet, and the hydrogen depleted purge gas is sent to a purge gas line 19. The purge gas 19 can be combined with diluted ammonia product stream 21 and exported to SCR. From the knockout drum, a small stream of ammonia liquid 24 is withdrawn and sent to a small on-site storage day tank (not shown).

The liquid anhydrous ammonia collected in the ammonia knockout drum 15 is stored under high pressure of 2000 to 2500 psig. During normal operation, the stored liquid ammonia expands through a Joule Thompson expansion valve 16. This ammonia expansion from high pressure to a low pressure (50 to 100 psig) produces a refrigeration effect that provides cooling for the ammonia condenser 14. The expanded ammonia gas is mixed with dilution air before it is sent out to SCR in the ammonia supply line 21. A dilution air supply is required because most SCR manufacturers require the reaction gas to contain only 5% of gaseous ammonia.

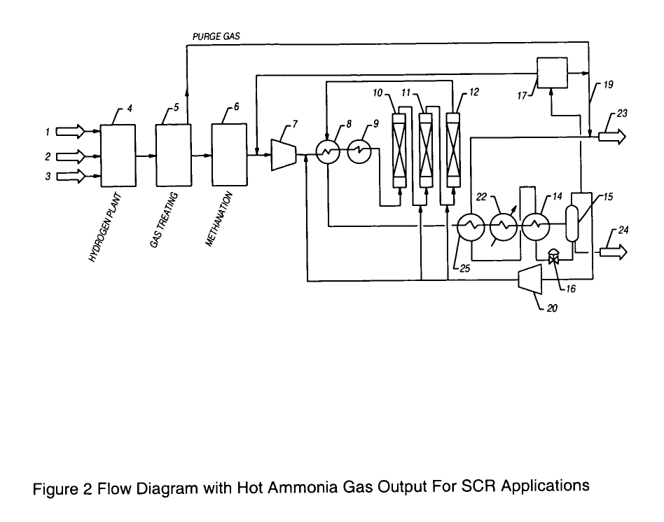

FIG. 2 depicts a flow diagram for the production of hot ammonia gas, without the dilution air, for SCR or SNCR applications. In this embodiment, an ammonia gas superheater 25 is used downstream of heater 8. A trim cooler 22 is used to further cool the reactor exit gas. Cooler 22 may be a water-cooled heat exchanger or an air-fan cooler. Cooled reactor effluent gas then enters ammonia condenser 14. The purge gas stream 19 is combined with the hot ammonia product gas 23 for use in SCR. In this design, the dilution air is not provided in the mini ammonia plant design. This alternative is suitable for long distance transport of ammonia gas, as it is more economical to transport ammonia gas than the diluted ammonia/air mixture.

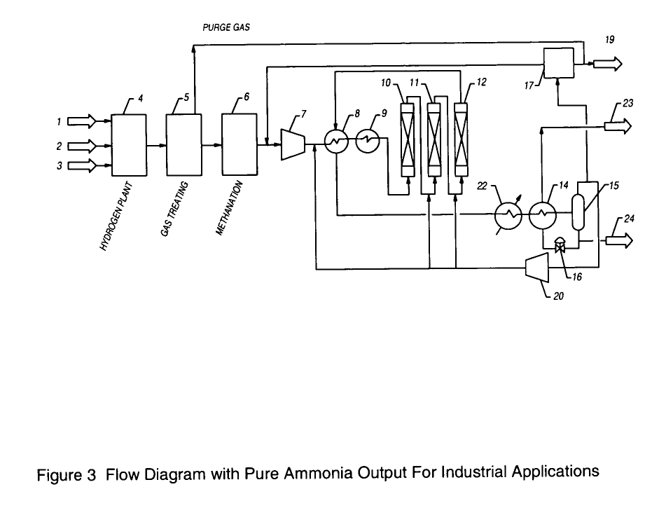

FIG. 3 depicts a flow diagram for the production of pure ammonia for industrial applications. In this case, purge gas streams from the gas treating system 5 and purge gas membrane 17 are combined to stream 19, and vented or burned in a furnace. The product gas 23 is not mixed with any purge gas and is a pure ammonia stream.

We claim the following:

1. A process of making a small quantity of diluted ammonia and air mixture from natural gas for use in power plant NOx abatement using SCR or SNCR, comprising the following steps:
a) Introducing a mixture of pre-conditioned hydrogen and nitrogen to a series of ammonia synthesis reactor made of a series of pipe sections wherein the said mixture is partially converted to ammonia. The reactor design will use conventional piping similar to that used in power plant superheated steam lines. Due to the low catalyst space velocity for the mini plant, the reactor pressure is reduced substantially from the current practice of 4000 psig or higher to about 2500 psig for the current design.
b) The liquid ammonia is vaporized and conditioned to facilitate its use in SCR. Ammonia conditioning includes gas heating or dilution with air to meet SCR feed gas requirements. This conditioning step eliminates certain equipment required in a conventional ammonia supply system for SCR. Unheated ammonia vapor can also be made for use in industrial applications.
c) All purge gas streams are combined into the product gas, so no emission point exists in the system.

2. An auto-refrigeration scheme that uses one of the following pressure expansion devices:
a) The use of a Joule-Thompson (J-T) expansion valve to generate refrigeration. Refrigeration is produce by pressure reduction of ammonia liquid from high pressure (example: from 2000 psig to less than 100 psig). Refrigeration is needed to fully condense the ammonia vapor in the ammonia synthesis reactor effluent gas stream. Unlike a conventional ammonia plant where an ammonia compressor is used to create refrigeration, this process requires no ammonia compressor.
b) The use of a capillary tube or orifice as the pressure reduction and gas expansion device in lieu of the above mentioned J-T valve.

3. An SCR ammonia supply conditioning system comprising two possible heat recovery schemes:
a) Recover waste heat from the synthesis reactor effluent to heat the dilution air supply. This scheme saves energy in the SCR system since the dilution air must be heated either by electricity or by steam in the current commercial practices that use aqueous ammonia or urea hydrolysis.
b) Recover synthesis reactor heat to heat the product ammonia gas to 300° C. or higher. If the distance between the ammonia skid and SCR ammonia feed point is long, it is more economical to transport highly concentrated hot ammonia gas than the 5% diluted ammonia gas.
